(19) United States
(12) Patent Application Publication
(10) Pub. No.: US 2025/0290273 A1
(43) Pub. Date: Sep. 18, 2025

(54) HYDROVAC WITH REAL-TIME WEIGHT MONITORING

(71) Applicant: Brandt Industries Canada Ltd., Regina (CA)

(72) Inventors: Evrhetton Gold, Regina (CA); Anthony Au, Regina (CA); Greg Thomson, Regina (CA); John Peters, Regina (CA); Daniel Bonnet, Regina Saskatchewan (CA)

(21) Appl. No.: 18/606,995

(22) Filed: Mar. 15, 2024

(51) Int. Cl. E02F 3/90; E02F 3/88; E02F 3/92; E02F 9/24; E02F 9/26; G01G 19/08; G01G 23/18

(52) U.S. Cl. CPC E02F 3/907; E02F 3/8816; E02F 3/9262; E02F 9/24; E02F 9/26; G01G 19/08; G01G 23/18

(57) ABSTRACT

A hydrovac and method for measuring the current weight of the hydrovac in real-time is provide. The current weight of the hydrovac can be determined by determine a weight of water in the at least one water tank using a pressure sensor, determining a weight of debris in a debris tank using at least one load cell, and using the determined weight of the water in the at least one water tank, the determined weight of the debris in the debris tank, and a predetermined empty weight of the hydrovac to determine a current weight of the hydrovac.

The present invention relates to a hydrovac and specifically a method of determining the weight of the hydrovac in real-time.

### BACKGROUND

Traditionally, excavation was performed using excavators, skid steers and/or backhoes and even manually digging with hand tools, such as shovels. However, in some cases excavation in this manner can cause damage and even be dangerous. For example, when excavating around utilities to expose them for repair or replacement, these machines can accidentally damage the utilities and even causes serious injuries or death if the utilities are high power electrical lines and the machinery or hand tools accidentally cuts through them.

More recently, hydro-evacuation trucks or “hydrovacs” are more commonly being used for excavation and particularly excavation around utilities. Hydrovacs use high pressure streams of water to cut into soil. This water liquifies the soil making into a slurry that can then “vacuumed” up by the hydrovac into the tank on the hydro-evacuation truck, along with any rocks and other debris contained into the slurry. Typically, the mixture of water, soil and rock in the tank of the hydro-evacuation truck cannot be used for backfill for the excavated hole because of the moisture content, so it has to be carried in the tank by the hydro-evacuation truck to a dump site.

Hydro-evacuation has many advantages over more traditional mechanical and physical labor based excavation, including significantly reducing the risks of excavating to expose utility lines (commonly referred to as “daylighting”) because the high pressure stream of water and vacuuming of the resulting water and soil mixture is very unlikely to damage buried utilities. It can also be used with heated water to improve its performance with frozen soil.

Because the hydrovacs are trucks, local laws and regulations will govern how much load (debris) a hydrovac can carry in payload before becoming overweight. An operator will have to ensure that the weight of the debris collected and transported by a hydrovac is below the legal limits. One way this can be determined is to weigh the entire truck. However, this is not desirable and requires a weigh scale station to be convenient to the excavation site.

Another method that has been used to try and estimate a weight of the hydrovac and its load is to measure the pressure in the air bags of the suspension in order to try and estimate the weight of hydrovac. However, such method is susceptible to errors from air temperature, the ground surface (i.e. is it level, potholes, etc.) and other factors which can result in inaccurate estimates in the varying environments in which hydrovacs are operated.

### SUMMARY OF THE INVENTION

In an aspect, a hydrovac having a frame, a cab mounted near a front end of the frame, an engine mounted on the frame, steering wheels connected to the frame and operative to steer the hydrovac, ground wheels connected to the frame, a vacuum hose fluidly connected to the debris tank, the vacuum hose having a distal end, a boom pivotally mounted at a first end and carrying the vacuum hose, a debris tank, a blower operatively connected to the debris tank and operative to create a vacuum in the debris tank, at least one load cell measuring the weight of the debris tank, at least one water tank, a pressure sensor measuring a pressure of the water at a bottom of the at least water tank, and a controller is provided. The controller having at least one processing unit, an input interface operatively connected to the at least one load cell and the pressure sensor, a human machine interface, and at least one memory containing program instructions. The controller is operative to determine a weight of water in the at least one water tank using the pressure sensor, determine a weight of debris in the debris tank using the at least one load cell, and use the determined weight of the water in the at least one water tank, the determined weight of the debris in the debris tank, and a predetermined empty weight of the hydrovac to determine a current weight of the hydrovac.

In another aspect, a method for measuring a current weight of a hydrovac is provided. The method comprising measuring a pressure in a bottom of a water tank to obtain a pressure measurement, using the pressure measurement and dimensions of the water tank to determine a weight of water in the water tank, measuring a weight of debris in a debris tank with at least one load cell and determining a weight of the debris by substracting the weight of the debris tank, and adding the weight of the water in the water tank and the weight of the debris to an empty weight of the hydrovac to determine the current weight of the hydrovac.

In another aspect, a controller for measuring a current weight of a hydrovac is having a frame, a cab, an engine mounted on the frame, steering wheels, ground wheels, a vacuum hose fluidly connected to the debris tank, a boom carrying the vacuum hose, a debris tank, a blower operatively connected to the debris tank and operative to create a vacuum in the debris tank, at least one load cell measuring the weight of the debris tank, at least one water tank, and, a pressure sensor measuring a pressure of the water at a bottom of the at least water tank. The controller can have at least one processing unit, an output interface operatively connected to the at least one load cell and the pressure sensor, and at least one memory containing program instructions. The at least one processing unit can be operative to: determine a weight of water in the at least one water tank using the pressure sensor; determine a weight of debris in the debris tank using the at least one load cell; and use the determined weight of the water in the at least one water tank, the determined weight of the debris in the debris tank, and a predetermined empty weight of the hydrovac to determine a current weight of the hydrovac.

### DESCRIPTION OF THE DRAWINGS

A preferred embodiment of the present invention is described below with reference to the accompanying drawings, in which:

FIG. 1 is a perspective view of a hydrovac;

FIG. 2 is driver side view of the hydrovac of FIG. 1;

FIG. 3 is a passenger side view of the hydrovac of FIG. 1;

FIG. 4 is a top view of the hydrovac of FIG. 1;

FIG. 5 is a rear view of the hyrdovac of FIG. 1;

FIG. 6 is a schematic illustration of an equipment compartment on the driver side of the hydrovac of FIG. 1;

FIG. 7 is a schematic illustration of a blower behind the equipment compartment in FIG. 6;

FIG. 8 is a schematic illustration of an equipment compartment on the passenger side of the hydrovac of FIG. 1;

FIG. 9 is a schematic illustration of a controller for the hydrovac;

FIG. 10 is a front view of a remote control for operating a hydrovac;

FIG. 11 is a schematic view of load cell sensors for measuring the weight of a debris tank;

FIG. 12 is a schematic view of water tanks to be mounted on a hydrovac;

FIG. 13 is an illustration of a display screen on the hydrovac; and

FIG. 14 is a free body diagram illustrating the forces applied to the hydrovac.

### DETAILED DESCRIPTION OF THE ILLUSTRATED EMBODIMENTS

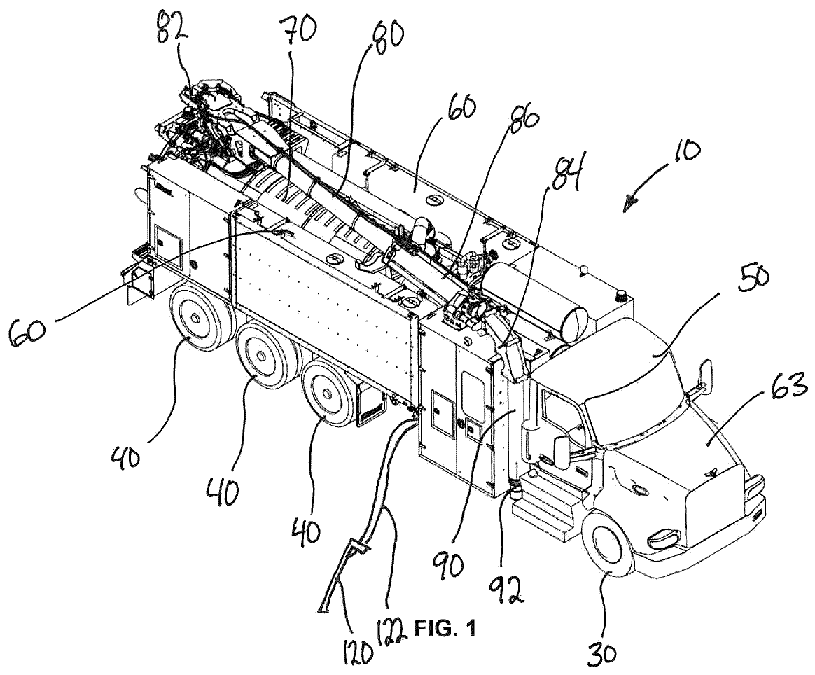

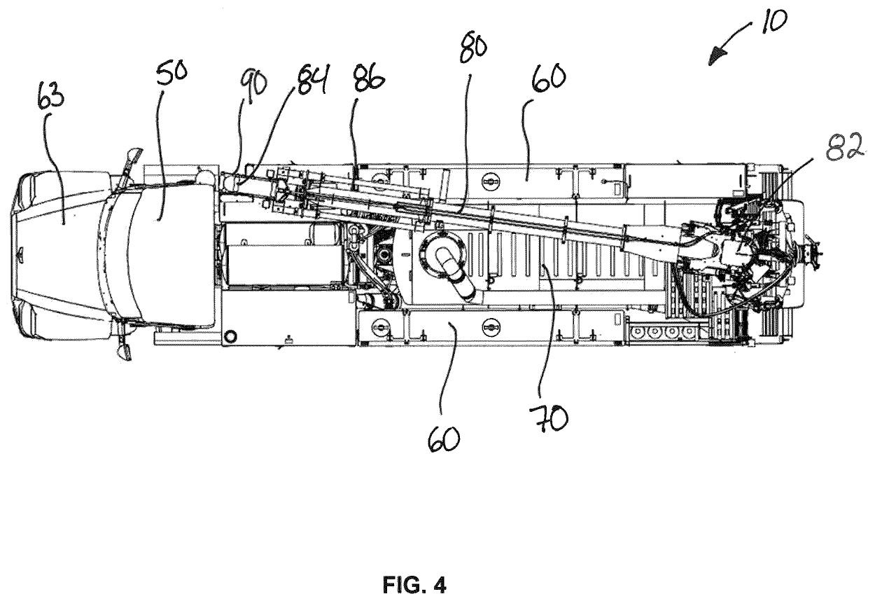

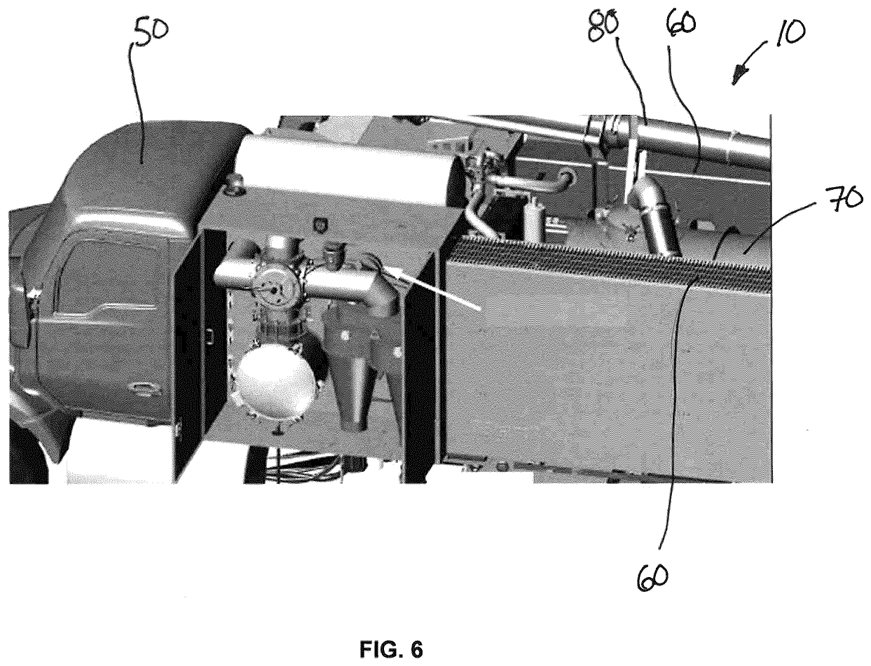

FIGS. 1-8 illustrate a hydro-evacuation truck or a hydrovac 10 for performing hydro-excuvations. The hydrovac 10 can include: a frame 20; steering wheels 30; ground wheels 40; a cab 50; an engine 63; a fuel tank 67; one or more water tanks 60; a debris tank 70; a boom 80; a vacuum hose 90; a blower 100; a controller 200; a water pump 110; and, a dig wand 120.

The frame 20 is supported by the steering wheels 30 and the ground wheels 40. The frame 20 supports the various components of the hydrovac 10. The steering wheels 30 are positioned near the front of the frame 20 and operative to steer the hydrovac 10. The steering wheels 30 can be provided on an axle 32.

The ground wheels 40 are operative to be driven by the engine 63 and move the frame 20 and therefore the hydrovac 10. The ground wheels 40 can be provided on axles 42.

The cab 50 can be mounted near a front end of the frame 20. The cab 50 can contain a passenger compartment and a hood enclosing the engine 53, such as an internal combustion engine.

The steering wheels 30 can be steered from the cab 50 and the engine 53 connected through a transmission (not shown) can be connected to the axles 42 of the ground wheels 40 to drive the ground wheels 40 and move the hydrovac 10.

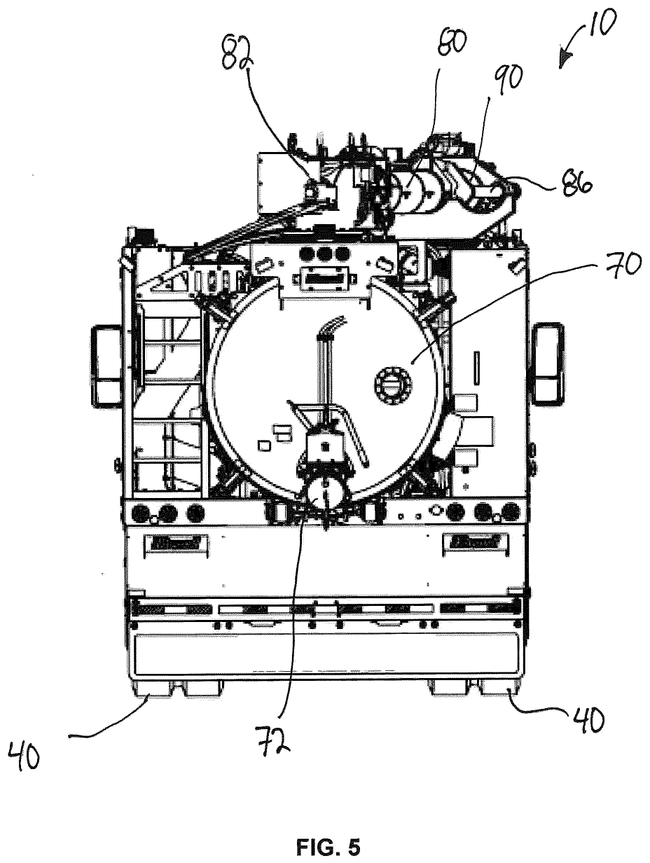

Referring again to FIGS. 1-8, the debris tank 70 can be mounted on the frame 20 behind the cab 50 with a rear end of the debris tank 70 positioned proximate a rear end of the hydrovac 10. The debris tank 70 can be used to store the soil and water slurry vacuumed up by the hydrovac 10. The debris tank 70 allows the slurry vacuumed up by the hydrovac 10 to be stored in the hydrovac 10 during its operation and then transported by the hydrovac 10 in the debris tank 70 to a dump site for disposal when the excavation is complete or the debris tank 70 is full. Referring to FIG. 5, the debris tank 70 can have a drain door 72 at the rear end of the debris tank 70 which can be opened to allow the debris tank 70 to be emptied or dumped out.

Referring again to FIGS. 1-8, the debris tank 70 can be provided with hydraulics so that a front end of the debris tank 70 can be lifted upwards, slanting the debris tank 70 downwards towards its rear end to aid dumping out the debris tank 70.

The boom 80 can be mounted proximate the rear end of the hydrovac 10 to carry the vacuum hose 90 and to maneuver the vacuum hose 90 to a side of the hydrovac 10 and in some cases even pivot the boom 80 around behind the hydrovac 10. In one aspect, the boom 80 can only maneuver the vacuum hose 90 to one side of the hyrovac 10, such as the passenger side of the hydrovac 10. The boom 80 allows the vacuum hose 90 to be maneuvered into a desired positioned to allow the vacuum hose 90 to suck up soil and any rocks or other debris that have been liquified into a slurry. The boom 80 can be pivotally mounted at a first end 82 so that the boom 80 can be pivoted from side to side around is first end 82 as well as being pivoted upwards and downwards around the first end 82 of the boom 80. A second end 84 of the boom 80 can be curved downwards to direct the vacuum hose 90 downwards towards a ground surface being excavated.

In one aspect, the boom 80 might have an extendable section 86 that allows the length of the boom 80 to be extendable and retractable to better enable an operator to maneuver the second end 84 of the boom 80 and therefore the vacuum hose 90 to a desired position.

The vacuum hose 90 can have a distal end 92. With portion of the vacuum hose 90 supported by the boom 80 and running along the boom 80, the distal end 92 of the vacuum hose 90 extends past the second end 84 of the boom 80 to that the distal end 92 of the vacuum hose 90 can be directed downwards towards the ground surface. An operator can position the distal end 92 of the vacuum hose 90 where they desire by pivoting the boom 80 from side to side and up and down.

When the hydrovac 10 is not in use or is going to be transported to another location, the boom 80 can be placed in a transport position with the boom 80 swung over top of the hydrovac 10, so that the second end 84 of the boom 80 and the vacuum hose 90 do not extend past the sides of the hydrovac 10. The boom 80 can be pivoted downward to be positioned against a top of the hydrovac 10.

The vacuum hose 90 can be flexible to allow it to bend so that it can bend as it is maneuvered by the boom 80 and bend downwards around the curved second end 84 of the boom 90 so that the distal end 92 of the vacuum hose 90 points downwards towards a ground surface to be excavated.

A dig tube (not shown) made of a rigid material, like aluminum, etc. can be attachable to the distal end 92 of the vacuum hose 90. This rigid dig tube can prevent damage and deformation to the vacuum hose 90 because it will be the dig tube that comes directly into contact with the liquified soil and other debris and is vacuumed up the dig tube first before the slurry enters then the vacuum hose 90 connected to the dig tube.

In one aspect, a portion of the vacuum hose 90 can be flexible while another portion of the vacuum hose 90 might be formed of rigid tubing, made of a rigid material such as metal. For example, a portion of the vacuum hose 90 that extends past the second end 84 of the boom 80 could be flexible tubing, while a portion of the vacuum hose 90 that runs along the boom 80 could be rigid tubing.

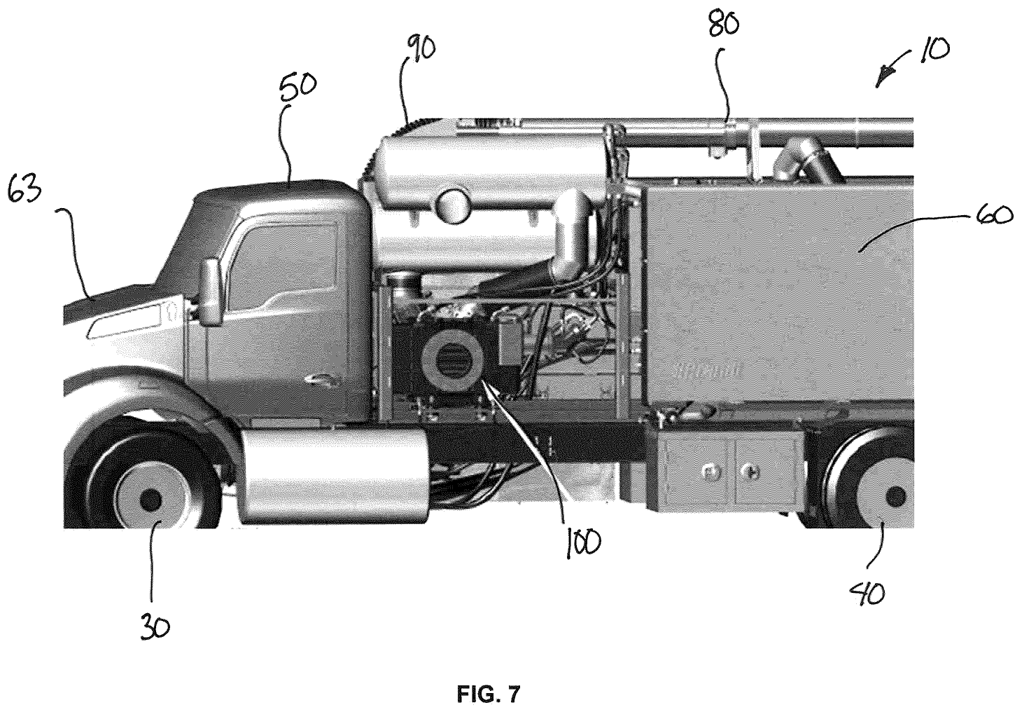

Referring to FIG. 7, the blower 100 can be used to create a vacuum in the debris tank 70. The vacuum hose 90 can be in fluid communication with the debris tank 70 and by creating a vacuum in the debris tank 70 suction will be created in the vacuum hose 90, allowing the vacuum hose 90 to suck a soil and water slurry through the vacuum hose 90 and into the debris tank 70.

Referring again to FIGS. 1-8, the water tanks 60 can be provided on the hydrovac 10 to supply water to the water pump 10 where the water will be pressurized and routed to the dig wand 120. The dig wand 120 can be connected to the hydrovac 10 with a hose 122 to provide pressurized water from the water tanks 60 and the water pump 110 to the dig wand 120.

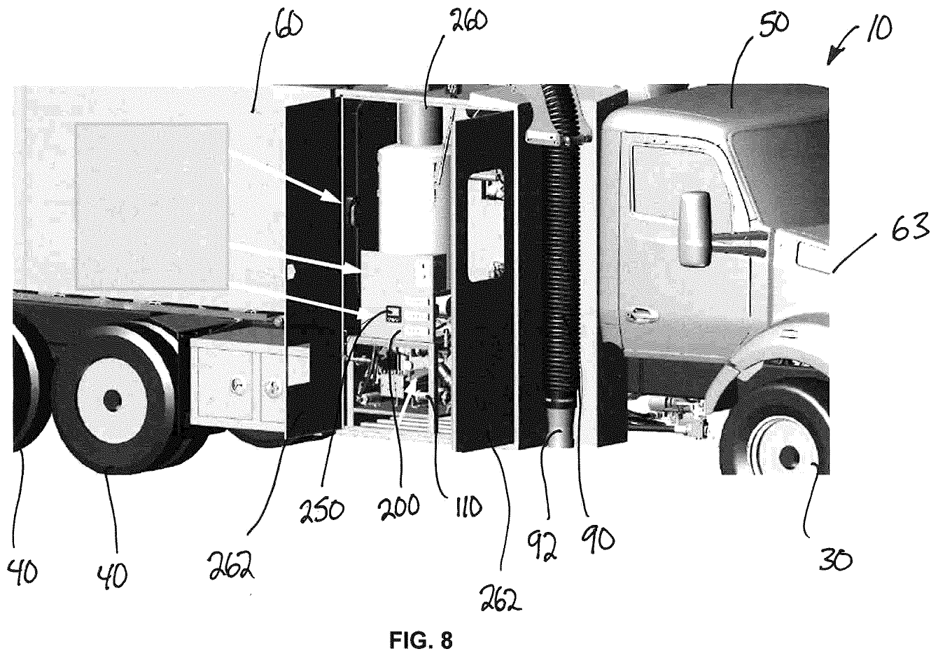

Referring to FIG. 8, the controller 200 can be used obtain information from various sensors to determine operating parameters of the hydrovac 10 and to control various components on the hydrovac 10. In one aspect, the controller 200 can control the operation of the blower 100, the water pump 110, and the boom 80.

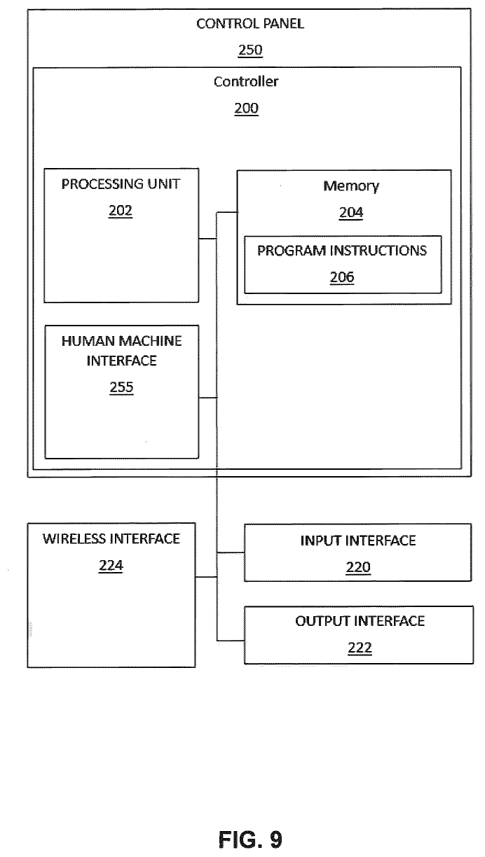

FIG. 9 is a schematic illustration of the controller 200, in one aspect. The controller 200 can include a processing unit 202, such as a microprocessor, that is operatively connected to a computer readable memory 204 and can control the operation of controller 200. Program instructions 206, for controlling the operation of the processing unit 202, can be stored in the memory 204 as well as any additional data needed for the operation of the controller 200.

A human machine interface 255, such as a touchpad, can be used by a user to interact with the controller 200.

A control panel 250 can be used to allow an operator to monitor the operation of the controller 200 and control its operation.

An input interface 220 can be provided operatively connected to the processing unit 202 so that the controller 200 can receive signals from external sensors.

Referring to FIGS. 1-9, an output interface 222 can be provided operatively connected to the processing unit 202 to send signals to other components on the hydrovac 10.

The output interface 222 can be connected to the boom 80 to control the operation of the boom 80 as well as the water pump 110, the engine 63, and the blower 100, as well as other components on the hydrovac 10.

The input interface 320 can be used to receive signals from the various sensors and other components on the hydrovac 10 to determine the status and operation of the hydrovac 10.

A wireless interface 224 can be used to allow a remote control to wirelessly connected to the controller 200 and allow the remoted control to control the operation of various components on the hydrovac 10 through the controller 200.

Referring to FIG. 8, the control panel 250 (and optionally the controller 200) can be located in a storage compartment 260 on a side of the hydrovac 10 for easy access by an operator. The storage compartment 260 can have doors 262 to enclose the control panel 250 when access is not required. The storage compartment 260 can also house the water pump 110 and store a remote control, that controls the operation of the hydrovac 10, when it is not required and, optionally, other components.

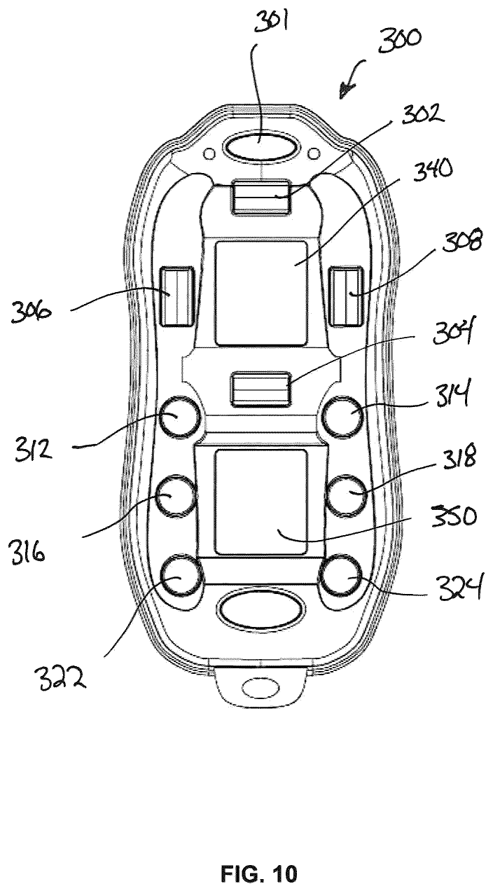

The movement of the boom 80, the operation of the blower 100, creating suction in the vacuum hose 90, and the water pump 110, can be controlled by a remote control that communicates with the controller 200 through the wireless interface 224. FIG. 10 illustrates a remote control 300 that can be used to control the operation of the hydrovac 10 by connecting through the wireless connection 224 of the controller 200 and controlling various components of the hydrovac 10 through the controller 200. In one aspect, the remote control 300 can have: a power on button 301; a boom up button 302; a boom down button 304; a rotate boom counter-clockwise button 306; a rotate boom clockwise button 308; a boom retract button 312; a boom extend button 314; a boom isolation button 316; an eco mode button 318; a water system on/off button 322; a water system pressure increase/decrease button 324; and, an emergency stop button 330. The various buttons can be used to control the operation of the hydrovac 10.

The remote control 300 may also contain one or more display screens for displaying information about the operation of the hydrovac 10, such as a levels screen 340, showing the level of water in the water tanks 60 and the level of debris in the debris tank 70, and a water system pressure screen 350 showing the pressure of the water in the system pressurized by the water pump 110.

Referring to FIGS. 1-8, in operation, the hydrovac 10 can be driven to a location where excavation is required. At the location, an operator can park the hydrovac 10 adjacent to where the excavation will occur and exit the hydrovac 10 to begin the hydro-evacuation process. The operator can then move the boom 80 to maneuver the vacuum hose 90 (such as with the remote control 300) over to one side of the hydrovac 10 towards the soil to be excavated and attach a dig tube to the distal end 92 of the vacuum hose 90. The operator can then maneuver the distal end 92 of the vacuum hose 90 and the attached dig tube over the soil to be excavated.

If the soil to be excavated is not already liquified to create a slurry that can be vacuumed up the vacuum tube 90, the operator can use the dig wand 120 and pressurized water supplied from the water tanks 60 by the water pump 110 to spray the pressurized water into the soil to liquify the soil and create a vacuumable slurry.

The operator can then start the blower 100 to create a vacuum in the vacuum hose 90 and direct the distal end 92 of the vacuum hose 90 towards the liquified soil to vacuum the soil slurry up through the vacuum hose 90 and into the debris tank 70.

When the excavation is complete or the debris tank 70 is full, the operator can stop spraying water with the dig wand 120 and stop the blower 100 from creating a vacuum in the vacuum hose 90. They can then disconnect the dig tube 95 from the distal end 92 of the vacuum hose 90 and maneuver the boom 80 to position the boom 80 and the vacuum hose 90 back over the hydrovac 10 and place it in a transport position. With everything stowed away on the hydrovac 10, the hydrovac 10 can be driven to a dump site and the debris tank 70 emptied.

If the debris tank 70 has hydraulics, the debris tank 70 the drain door 72 can be opened and the debris tank 70 tilted to dump out the contents of the debris tank 70 at the dump site.

During a hydro-evacuation operation, it is desirable to have an accurate current determination of the weight of the hydrovac 10. Local laws and regulations set out how much weight a truck, like the hydrovac 10 can carry and transport. The weight of the hydrovac 10 with a load of debris in the debris tank 70, must be kept under the legal limits. In other cases, the weight of the hydrovac 10 may just want to be kept under a specific weight for safety.

Determining the weight of the hydrovac 10 in real-time, specifically while the hydrovac 10 is being used to perform hydro-excavation, allows an operator to monitor the payload of the hydrovac 10 during its hydro-evacuation operation, including while the hydrovac 10 is suctioning up debris. However, as the hydovac 10 is being used for hydro-excavation, the weight of the hydrovac 10 will change. As the vacuum hose 90 is used to suck up liquified slurry into the debris tank 70, the debris tank 70 will fill with this mud, rock and other debris, causing the weight of the hydrovac 10 to increase. However, at the same time, use of the dig wand 120 to spray pressurized water supplied by the water tanks 60, will cause the amount of water in the water tanks 60 to decrease, lowering the weight of the hydrovac 10. Additionally, depending on how long the hydrovac 10 is operating, fuel will be burned, reducing the fuel in the fuel tanks and therefore the weight of the hydrovac 10. All of these changes to the overall weight of the hydrovac 10 make for a dynamic changing of weight, with some operations of the hydrovac 10 increasing the overall weight (e.g. sucking up debris), while other operations reduce it (e.g. burning fuel and spraying water from the water tanks 60).

Having an accurate weight of the hydrovac 10 and specifically its payload is important to prevent the hydrovac 10 from being overloaded and surpassing legal weight limits. Additionally, the more accurate the determination of the actual weight of the hydrovac 10 in real-time, the closer an operator can get to the payload without going into an overloaded state, allowing the operator to optimize payloads and carrying more debris while still staying under the legal limits. By maximizing the amount of debris that can be collected and transported in each trip, the more efficiently the hydrovac 10 can be used.

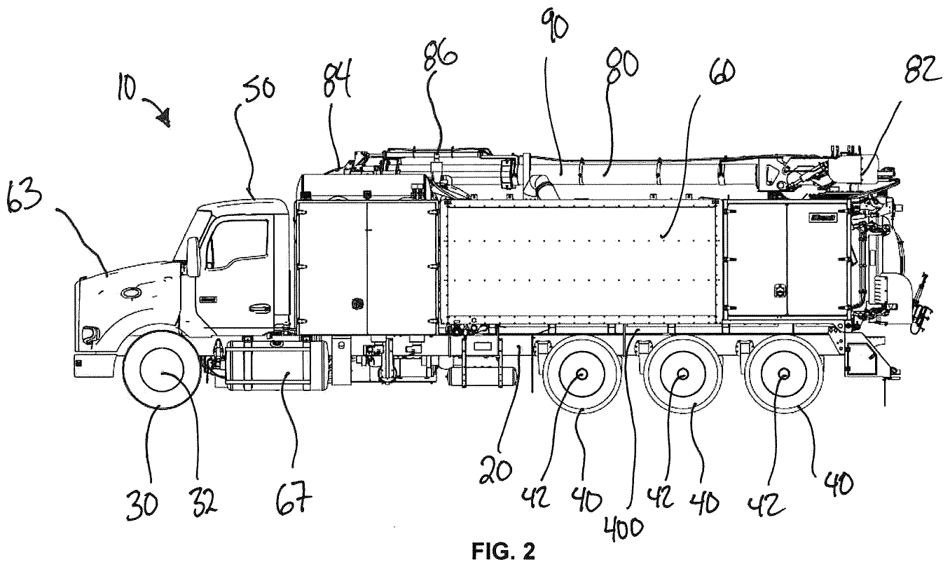

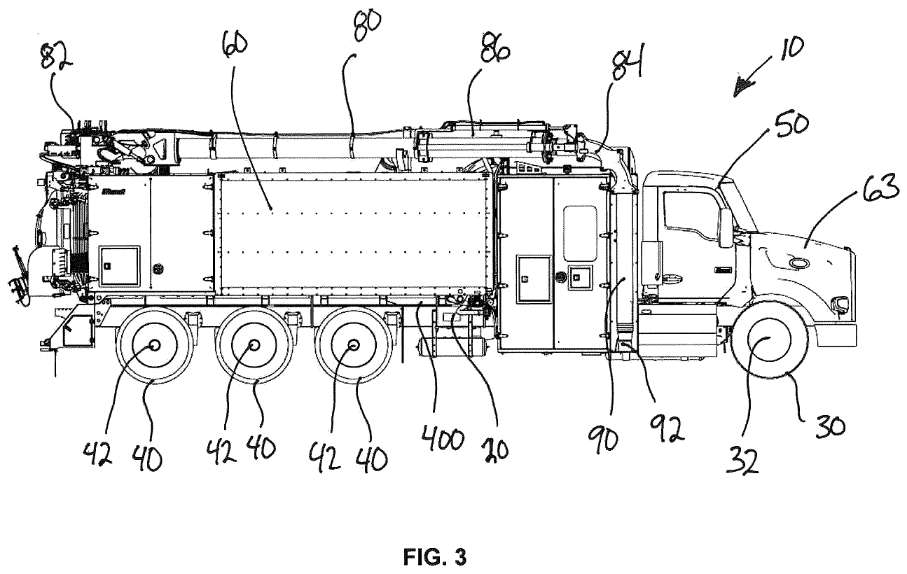

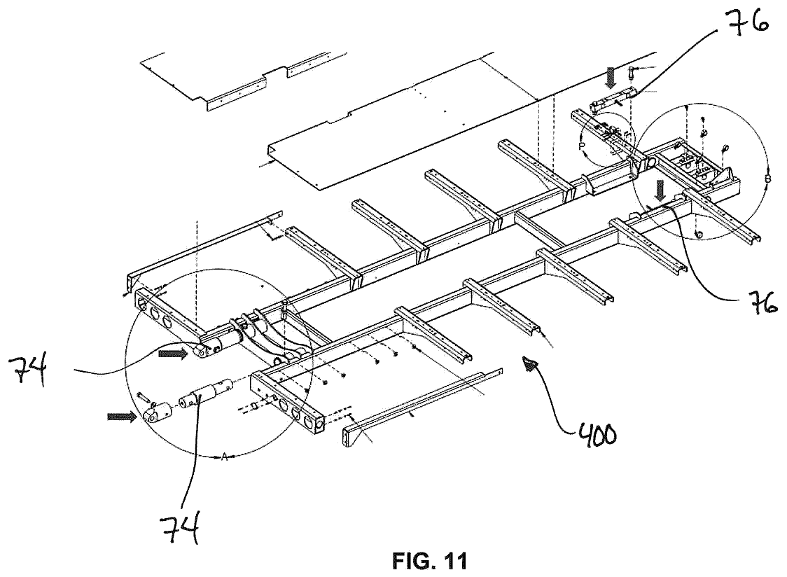

To measure the weight of the debris, the debris tank 70 can be mounted on a plurality of load cells 74, 76. Referring to FIG. 11, a substructure 400 is shown that the debris tanks 70 and the water tanks 60 can be mounted on (this substructure 400 can also be seen in FIGS. 2 and 3). This substructure 400 can be mounted on the frame 20 of the hydrovac 10. The debris tank 70 can be mounted on four load cell sensors 74, 76, with two front load cells 74 positioned near the front of the debris tank 70 and two rear load cells 76 positioned near a rear of the debris tank 70. These four load cells 74, 76, combined, can measure the weight of the debris tank 70 and the weight of any contents of the debris tank 70.

The load cells 74, 76 can be operatively connected to the input interface 220 of the controller 200 to communicate the measurements of these load cells 74, 76 to the controller 200. By knowing the weight of the debris tank 70 when it is empty, the weight of the contents of the debris tank 70 can be determined by taking the measurements of the load cells 74, 76 and subtracting the weight of the empty debris tank 70.

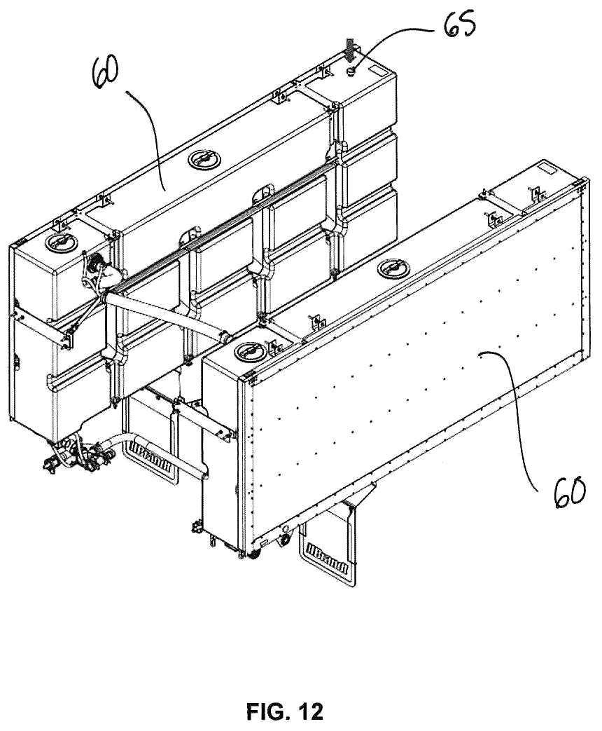

Referring to FIG. 12, to determine the amount of water in the water tanks 60 in real-time, a pressure sensor 65 can be provided in the water tank 60, measuring a pressure of the water in the water tank 60 at a bottom of the water tank 60. Using this pressure measurement from the pressure sensor 65 and the dimensions of the water tank 60, including the height of the water tank 60, the volume of the water in the water tank 60 can be determined and using the volume of the water, a weight of the water in the water tank 60 when the measurement was taken can be determined.

The pressure sensor 65 can be operatively connected to the input interface 220 of the controller 200 to communicate the measurements of the pressure sensor 65 to the controller 200.

If the water tanks 60 are the same dimensionally and are fluidly linked so that the water level in each water tank 60 is substantially the same, a single pressure sensor 65 in one of the water tanks 60 could be used to approximate the weight of the water in both water tanks 60.

Optionally, the fuel level can be used to approximate the weight of the fuel in the hydrovac 10 in real-time. The amount of fuel in the fuel tank 67 cam be tracked and, using the volume of the fuel tank 67, the weight of the fuel remaining in the fuel tank 67 can be determined.

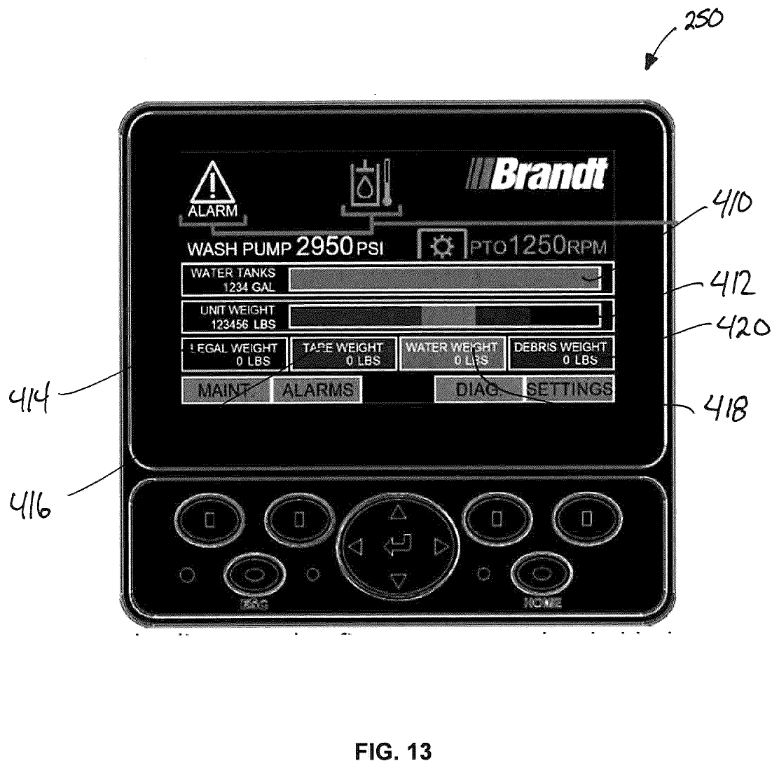

Referring to FIG. 13, the control panel 250 is shown that will display a number of measured and calculated weights on the hydrovac 10 to allow an operator to know when to stop sucking up debris into the debris tank 70 so that the hydrovac 10 does not exceed the legal limit for weight. The control panel 250 can display a number of measured and real-time determined weights and other information, such as the water tank level 410, the unit weight 412, the legal weight 414, the tare weight 416, the water weight 418, and the debris weight 420.

The water tank level 410 can display the amount of water in the water tanks 60 in real-time, determined by the pressure measurements taken by the pressure sensors 65.

The legal weight 414 can be input into the system and display the weight limit desired for the hydrovac 10. This can be a maximum weight for safety or a legal weight limit for a jurisdiction the hydrovac 10 is operation in. The legal weight limit for can vary by jurisdiction so while it will not change dynamically during operation of the hydrovac 10, it could be inputtable by a user to allow for the jurisdiction the hydrovac 10 is being used in and that jurisdiction's requirements for legal weights.

The tarre weight 416 can display the empty weight of the hydrovac 10 without debris in the debris tank 70, water in the water tanks 60, fuel in the fuel tank 67, etc.

The water weight 418 can display a determined weight of the water on the hydrovac 10 in real-time with the water weight calculated from the pressure sensors 65 in the water tanks 60 and using the dimensions of the water tanks 60 to determine a volume with the weight of water.

The debris weight 420 can display a measured weigh of debris in the debris tank 70 as measured from the load cell sensors 74, 76.

Finally, the unit weight 412 can display a current weight of the hydrovac 10 calculated in real-time using the empty weight, the water weight, the debris weight and a fuel weight.

In one aspect, the controller 200 can use a predetermined empty weight of the hydrovac 10 (the weight of the unloaded or empty hydrovac 10) and add the determined weight of the water in the water tanks 60, the determined weight of the debris in the debris tank 70 to the empty weight of the hydrovac 10 to determine a current weight of the hydrovac 10 at that particular time. This empty weight of the hydrovac 10 (i.e. the tarre weight) can be determined in advance by weighing the hydrovac 10, such as with a weight scale, when the hydrovac 10 is empty without any debris in the debris tank 70, water in the water tanks 60 and fuel in the fuel tanks 67, etc. and this measured empty weight can be input to the controller 200 as a constant.

The current weight of the hydrovac 10 can then be compared to the weight limit input into the controller 200 by an operator to see if the hydrovac 10 is approaching or at the weight limit. If it is, the controller 200 can initiate an alarm, such as a visual or audible alarm, to alert the operator and then operator can then stop hydro-evacuating with the hydrovac 10.

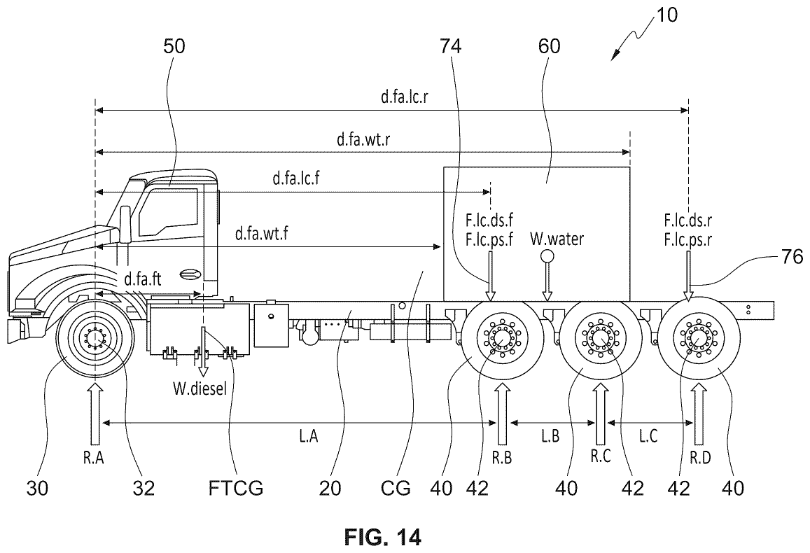

Along with, determining an overall current weight of the hydrovac 10 in real-time, the measured and determined weights can be used to determine the weight supported by each axle 32, 42 of the hydrovac 10. FIG. 14 illustrates a two-dimensional free body diagram of the hydrovac 10 that shows how the weight supported by the steering wheels 30 and the axle 32 attached to these steering wheels 30, and the ground wheels 40 and the axles 42 attached to each pair of ground wheel 40 can be determined using the measured weights and the distances these measured weights are acting from the axles 32, 42.

The empty weight of the hydrovac and the center of gravity, CG, of the empty hydrovac 10 can be used as one force acting on the axles 32, 42.

The measured load of the front load cells 74 and their position and the measured load of the rear load cells 74 and their position can be used for the force applied to the hydrovac by debris in the debris tank 70.

The determined weight of the water in the water tanks 60 using the pressure sensors 65 in the water tanks 60 and the position of the water tanks 60 can be used to determine the forces of the water acting on the hydrovac 10.

The weight of the fuel of the hydrovac 10 and the position of center of gravity of the fuel tank 67, FTCG, can be used to determine the forces acting on the hydrovac 10 from the fuel in the fuel tank 67.

With the positions of the axle 32 of the steering wheels 30 and the positions of the axles 42 of the ground wheels 40, and the known positions and forces on the hydrovac 10. The weight each axle 32, 42 is subjected to by the weight of the hydrovac 10 can be determined by the controller 200. With distance L.A. between the front axle 32 and the axle 42 of the front ground wheel 40, the distance L.B. between the axle 42 of the front ground wheel 40 and the axle 42 of the next ground wheel 40, and the distance L.C. between the axle 42 of the middle ground wheel 40 and the axle 42 of the last ground wheel 40, the positions of the axles 32, 42 will be known.

With the distance, d.fa.ft known between the axle 32 of the steering wheels 30 and the center of gravity of the fuel tank 67, WTCG, the distant between the axle 32 of the steering wheels 30 and the and the center of gravity of the hydrovac 10, CG, the distance, d.fa.wt.f, between the axle 32 of the steering wheels 30 and the front of the water tanks 60, the distance, d.fa.lc.f, between the axle 32 of the steering wheels 30 and the front load cells 74, the distance, d.fa.wt.r, between the axle 32 of the steering wheels 30 and the rear of the water tanks 60, and the distance, d.lc.ds.r, between the axle 32 of the steering wheels 30 and the rear load cells 76, the controller 200 can calculate the forces each axle 32, 42 is subjected to.

If the controller 200 determines that the force on any axle 32, 42 is at or approaching a legal limit, the controller 200 can initiate an alarm, such as a visual or audible alarm, to alert the operator and then the operator can stop hydro-evacuating with the hydrovac 10.

This weight limit can be the weight any axle 32, 42 is subjected to by the load on the hydrovac 10 or it could be a ratio of loads between axles 32, 42.

The foregoing is considered as illustrative only of the principles of the invention and the preferred embodiment. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A hydrovac comprising:
a frame;
a cab mounted near a front end of the frame;
an engine mounted on the frame;
steering wheels connected to the frame and operative to steer the hydrovac;
ground wheels connected to the frame;
a vacuum hose fluidly connected to a debris tank, the vacuum hose having a distal end;
a boom pivotally mounted at a first end and carrying the vacuum hose;
the debris tank;
a blower operatively connected to the debris tank and operative to create a vacuum in the debris tank;
at least one load cell measuring the weight of the debris tank;
at least one water tank;
a pressure sensor measuring a pressure of the water at a bottom of the at least water tank;
a controller, comprising: at least one processing unit; an input interface operatively connected to the at least one load cell and the pressure sensor; a human machine interface; and, at least one memory containing program instructions,
wherein the controller is operative to:
determine a weight of water in the at least one water tank using the pressure sensor;
determine a weight of debris in the debris tank using the at least one load cell;
use the determined weight of the water in the at least one water tank, the determined weight of the debris in the debris tank, and a predetermined empty weight of the hydrovac to determine a current weight of the hydrovac.

2. The hydrovac of claim 1 wherein the controller is further operative to compare the current weight of the hydrovac to a weight limit.

3. The hydrovac of claim 1 wherein a pair of load cells are positioned proximate a front of the debris tank and a pair of load cells are positioned proximate a rear of the debris tank.

4. The hydrovac of claim 2 wherein the controller is operative to, if the current weight of the hydrovac is approaching the weight limit, initiate an alarm.

5. The hydrovac of claim 4 wherein the alarm is at least one of: an audible alarm; and a visual alarm.

6. The hydrovac of claim 1 further comprising a fuel tank and wherein the controller is further operative to use a determined weight of fuel in the fuel tank to determine the current weight of the hydrovac.

7. The hydrovac of claim 1 further comprising a first axle for the steering wheels and at least one axle for the ground wheels, wherein the controller is operative to determine a weight on each of the first axle for the steering wheels and the at least one axle for the ground wheels based on the determined weight of the water in the at least one water tank, the determined weight of the debris in the debris tank, and the predetermined empty weight of the hydrovac to determine a current weight of the hydrovac.

8. The hydrovac of claim 7 further comprising a fuel tank and wherein the controller is further operative to use a determined weight of fuel in the fuel tank to determine the current weight of the hydrovac.

9. A method for measuring a current weight of a hydrovac, the method comprising:
measuring a pressure in a bottom of a water tank to obtain a pressure measurement;
using the pressure measurement and dimensions of the water tank to determine a weight of water in the water tank;
measuring a weight of debris in a debris tank with at least one load cell and determining a weight of the debris by substracting the weight of the debris tank;
adding the weight of the water in the water tank and the weight of the debris to an empty weight of the hydrovac to determine the current weight of the hydrovac.

10. The method of claim 8 further comprising measuring an amount of fuel in a fuel tank and determing a weight of fuel in the fuel tank and adding the weight of fuel in the fuel tank, the weight of the water in the water tank and the weight of the debris to an empty weight of the hydrovac to determine the current weight of the hydrovac.

11. A controller for measuring a current weight of a hydrovac comprising: a frame; a cab; an engine mounted on the frame; steering wheels; ground wheels; a vacuum hose fluidly connected to the debris tank; a boom carrying the vacuum hose; a debris tank; a blower operatively connected to the debris tank and operative to create a vacuum in the debris tank; at least one load cell measuring the weight of the debris tank; at least one water tank; and, a pressure sensor measuring a pressure of the water at a bottom of the at least water tank, the controller comprising:
at least one processing unit;
an output interface operatively connected to the at least one load cell and the pressure sensor; and
at least one memory containing program instructions, the at least one processing unit, responsive to the program instructions, operative to:
determine a weight of water in the at least one water tank using the pressure sensor;
determine a weight of debris in the debris tank using the at least one load cell; and,
use the determined weight of the water in the at least one water tank, the determined weight of the debris in the debris tank, and a predetermined empty weight of the hydrovac to determine a current weight of the hydrovac.

12. The controller of claim 11 further operative to compare the current weight of the hydrovac to a weight limit.

13. The controller of claim 12 wherein the controller is operative to, if the current weight of the hydrovac is approaching the weight limit, initiate an alarm.

14. The controller of claim 13 wherein the alarm is at least one of: an audible alarm; and a visual alarm.

15. The controller of claim 11 further operative to determine a weight of fuel in a fuel tank of the hydrovac and use the determined weight of fuel in the fuel tank of the hydrovac to determine the current weight of the hydrovac
